(19) United States
(12) Patent Application Publication
(10) Pub. No.: US 2026/0287930 A1
(43) Pub. Date: Sep. 24, 2026

(54) REDUCING THE PROGRESSION OF MYOPIA BY MEANS OF AN ADAPTED ACTIVE REGION

(71) Applicant: Rodenstock GmbH, Muenchen (DE)

(72) Inventors: Matthias Rosensteiner, Ismaning (DE); Gregor Esser, Muenchen (DE); Martin Zimmermann, Erdweg-Kleinberghofen (DE); Anne Seidemann, Muenchen (DE); Helmut Altheimer, Baisweil-Lauchdorf (DE)

(21) Appl. No.: 19/477,629

(22) PCT Filed: Apr. 24, 2024
(86) PCT No.: PCT/EP2024/061209

§ 371 Date: Oct. 22, 2025

(30) Foreign Application Priority Data
Apr. 24, 2023 (DE) 10 2023 110 431.4

(51) Int. Cl. G02C 7/02

(52) U.S. Cl. CPC G02C 7/028; G02C 2202/24

(57) ABSTRACT

A method for calculating or optimizing a spectacle lens for at least one eye of a spectacle wearer such that the spectacle lens includes a central main viewing region with a substantially constant refractive power; and an effect region adjacent to the central main viewing region, which causes at least partially a higher refractive power than the refractive power in the central main viewing region and/or at least partially a reduction in contrast. The method includes providing user data comprising at least a spherical equivalent of a refractive deficit of the at least one eye, determining a primary refractive power as the substantially constant refractive power of the central main viewing region for correcting the spherical equivalent of the refractive deficit of the at least one eye, and ascertaining a horizontal and/or vertical extension of the central main viewing region as a function of the primary refractive power.

### TECHNICAL FIELD

The invention relates to the improvement of the balance between effectiveness and tolerability of spectacle lenses in the reduction of the progression of myopia.

### BACKGROUND

Myopia management is understood to mean the attempt to control abnormal growth of the eyeball's length, particularly in children and adolescents, which leads to severe myopia and is caused inter alia by a lifestyle dictated by modern society (little time outdoors and plenty of nearwork). One possible approach to controlling the progression of myopia is wearing special spectacle lenses that attempt to move the focal plane of the visual field in the periphery in front of the retina and thus slow the growth of the eyeball's length.

One possibility is spectacle lenses with a design similar to progressive lenses, which in the periphery, by an addition in power, bring the focal plane in the peripheral visual field in front of the retina. (e.g. U.S. Pat. No. 7,025,460, EP 1 934 648 B1, WO 2017/222421 A1, DE 10 2009 053 467 B4). Other spectacle lens variants have a multitude of small additional optical elements (lenslets, etc.) distributed across the spectacle lens and creating a second focal plane in front of the retina (e.g. CN 104678572 B, U.S. Pat. No. 10,268,050 B2, WO 2019/166653 A1, U.S. Pat. Nos. 8,950,860 B2, 10,901,237 B2, 11,061,255 B2). Another possibility is the insertion of small scatterers that reduce contrast in the periphery and thus inhibit the progression of myopia (e.g. WO 2018/026697 A1).

All of these spectacle lenses have in common that they have a central region that provides good vision due to a prescription of a corresponding corrective power, as well as a peripheral zone that does not provide good vision due to myopia management measures (lenslets, power increase, or scatterers). The size of the central zone is crucial for the tolerability of the spectacles, the size of the peripheral effect region is crucial for the success of myopia management. The ratio of the two zones is usually determined by the lens design and is the same for all corrective powers. Suggestions for adapting the zones to the individual eye are described e.g. in EP 3 966 626 A1. They are based on additional measurements, either as peripheral refraction or using a psychophysical method.

In particular in spectacle lenses for correcting myopia, the often noticeable tendency for myopia progression leads to a decrease in the wearing comfort of once fitted spectacle lenses, and thus also the wearer's satisfaction and the tolerability of the spectacles, after a short period of time.

To date, various optical powers regarding the tolerability and comfort of spectacle lenses, in particular spectacle lenses, have been examined with regard to their influence on myopia and/or hyperopia, as well as their progression or development depending on the optical and physiological mechanisms that are intended to explain or slow down progression or advancement, in particular deterioration. Existing approaches are substantially based on imaging the image in front of the retina, as this is intended to slow the growth of the eyeball's length. It has been shown that it is sufficient (or even better) if this occurs only in the periphery of the retina.

### SUMMARY

It is an object of the present invention to improve lasting tolerability of spectacles or spectacle lenses and thus achieve long-term wearing comfort in a cost-effective manner. According to the invention, this object is achieved by the subject matter of the independent claims. Preferred embodiments are the subject of the dependent claims.

Thus, in one aspect, the invention relates in particular to a computer-implemented method for calculating or optimizing a spectacle lens for at least one eye of a spectacle wearer such that the spectacle lens comprises a central main viewing region with a substantially constant refractive power (hereinafter also referred to as the primary refractive power) and an effect region adjacent to the central main viewing region. The primary refractive power in the central main viewing region is to be considered substantially constant in particular in that the variations in the refractive power within the central main viewing region are within a range of no more than about 1 dpt, preferably no more than about 0.5 dpt, most preferably no more than about 0.25 dpt.

The effect region of the spectacle lens to be calculated or optimized causes an at least partially higher refractive power (hereinafter also referred to as the secondary refractive power) than the refractive power in the central main viewing region and/or at least partially a reduction in contrast (compared to the central main viewing region).

Particularly in the case of an effect region with increased refractive power (compared to the central main viewing region), the central main viewing region could preferably be considered to be a convex surface (in particular an elliptical surface, preferably a circular surface) with maximum surface area and/or with maximum horizontal and/or vertical extension, at the edge of which the refractive power of the spectacle lens does not exceed a certain limit value. In particular, this limit value could be a refractive power that is greater by a specified primary tolerance value than a minimum value or an average value of the refractive power within the central main viewing region. Such a primary tolerance value is preferably not greater than about 1 dpt, particularly preferably not greater than about 0.5 dpt, and most preferably not greater than about 0.25 dpt.

The increase in refractive power in the effect region (compared to the central main viewing region) could, for example, be achieved by a continuous increase in the surface refractive power (similar to a PAL) and/or by refractive microstructures (e.g., lenslets) and/or by diffractive structures.

To achieve a reduction in contrast in the effect region, the spectacle lens could have surface roughness in the effect region, which causes a dullness of the optical image through the lens, for example. This dullness could then lead to a reduction in contrast. Here, the central main viewing region could remain substantially clear, while the reduction in contrast is only created in the effect region. This reduction in contrast contributes to the fact that the central peripheral field of vision provides no or less incentive for a growth of the eyeball's length.

Particularly in the case of an effect region with a reduction in contrast (compared to the main viewing region), the main viewing region could preferably be considered to be a convex surface (in particular an elliptical surface, preferably a circular surface) with maximum surface area and/or with maximum horizontal and/or vertical extension, at the edge of which the contrast of the image created by the spectacle lens does not fall below a certain limit value. In particular, this limit value could be such that the perception (or a degree of perception) created thereby lies in the range of at least about 0.5, preferably at least about 0.7, even more preferably at least about 0.8, most preferably at least about 0.9.

Perception should be understood here in particular as the factor by which the visus (i.e., visual acuity) is reduced, wherein a visual acuity determined to be a value of 1 according to DIN 58220 Part 3 is assumed as a reference. Thus, a perception of 0 (<0.1) means substantially complete occlusion, and 1, in principle, complete transparency. These properties arise in particular when the spectacle lens is arranged in a position with a typical corneal vertex distance (CVD), i.e. in particular when at least one CVD value is in the range of about 11 mm to about 18 mm, in particular preferably when at least one CVD value is about 13 mm or about 14 mm.

Alternatively or in addition to complying with the value ranges for perception proposed here, it may be in particular preferred if the reduction in contrast caused by the microstructure in the effect region results in a haze value (in particular % haze) according to the ASTM D-1003 standard in the range of no more than about 10, preferably in the range of no more than about 2, and preferably the reduction in contrast caused by the microstructure in the effect region results in a haze value according to the ASTM D-1003 standard in the range of at least about 0.1, in particular at least about 0.5.

Particularly preferably, in the case of a reduction in contrast, the effect region still has a transmission (in particular a luminous transmittance value according to the ASTM D-1003 standard) of at least 85, even more preferably at least 90. This ensures that even in the case of a reduction in contrast, the spectacle lens does not completely block the light (e.g. absorbs and/or reflects it) and thus darken the field of vision, but that the light is only (partially) scattered. This largely preserves the impression of brightness and prevents the pupil from becoming noticeably enlarged (due to reduced light incidence).

The values for both haze and luminous transmittance according to the ASTM D-1003 standard can be ascertained or verified, for example, using the “haze-gard plus” measuring device from BYK Additives and Instruments.

The method according to the invention comprises providing user data comprising at least one spherical equivalent of a refractive deficit of the at least one eye. The spherical equivalent of the refractive deficit refers to the spherical component of the vision defect, in particular myopia. Here, in particular the spherical equivalent of the refractive deficit of the central (or foveal) field of vision is provided. Providing user data can, in particular, comprise directly ascertaining or measuring and/or providing previously measured and then, in particular, stored information. Providing can, in particular, comprise entering or transmitting the user data via a user interface and/or a data interface of a data processing system.

The method also comprises determining the primary refractive power as the substantially constant refractive power of the central main viewing region for correcting the spherical equivalent of the refractive deficit of at least one eye, and ascertaining a horizontal and/or vertical extension of the central main viewing region based on (or as a function of) the primary refractive power.

The horizontal and/or vertical extension of the central main viewing region is ascertained, in particular, based on (or as a function of) the primary refractive power by ascertaining, namely calculating or reading out, the horizontal or vertical extension depending on the (pre)determined value of the primary refractive power, in particular based on a predefined rule or assignment. Such a rule or assignment can, in particular, be a functional relationship, e.g. in the form of an (analytical) formula, between the primary refractive power and the horizontal or vertical extension.

In a further preferred embodiment, such a rule or assignment can be a table (e.g. an assignment or reference table) with predefined values or value ranges, which assigns a corresponding value for the horizontal or vertical extension of the central main viewing region to each value of a primary refractive power. The use of such a table can be particularly advantageous when, in the course of ascertaining the horizontal and/or vertical extension of the central main viewing region, a spectacle lens (or spectacle lens blank) is selected from a series of spectacle lenses (or spectacle lens blanks). Intervals of a primary refractive power (e.g. 1.5-2 dpt) can be assigned to a specific value of the horizontal or vertical extension of the main viewing region.

In a preferred aspect, the (functional) relationship used to ascertain the horizontal or vertical extension of the central main viewing region can be such that the ascertained extension of the central main viewing region results in a predetermined dimension (e.g. angular extension) of the field of sight. Preferably, the predetermined dimension (e.g. angular extension) of the field of sight can be substantially constant within a spectacle lens series.

The (predetermined) relationship (e.g. formula, table, etc.) between the primary refractive power and the horizontal and/or vertical extension of the central main viewing region may also depend on one or more additional parameters, e.g. in addition to the refractive power, the distance of spectacle lens-eye and/or the position or distance of the ocular center of rotation from the spectacle lens, etc.

Thus, present invention in particular proposes calculating or optimizing the size of the central main viewing region and/or the effect region depending on the distortion of the field of sight, thus achieving an updated and thus at least improved balance between tolerability and effectiveness of the spectacle lens in suppressing a progression of myopia for each power.

Thus, within the scope of the present invention, it was particularly recognized that, strictly speaking, it is not (solely) the size of the central zone that determines the (long-term) tolerability of the spectacle lens, but (not insignificantly) the size of the field of sight to which this central zone of the spectacle lens corresponds. The size of the field of sight depends not only on the central zone but also on the angular distortion of the spectacle lens. This is determined inter alia by the power of the spectacle lens and, in particular, also by the distance of the spectacle lens from the ocular center of rotation. In a particularly preferred embodiment, the inherent magnification of the spectacle lens is also determined, and the horizontal and/or vertical extension of the central main viewing region is ascertained taking the inherent magnification into account.

Preferably, the horizontal and/or vertical extension of the central main viewing region is ascertained as a (at least partially) monotonically increasing function of the primary refractive power of the spectacle lens. In the context of this development, it was particularly recognized that this can very effectively counteract an effect which conventionally results in the size of the field of sight of the central zone (particularly for foveal vision), with the same physical size on the spectacle lens, changing due to dynamic distortion when the corrective power (particularly the primary refractive power) changes in such a way that an optimum of a balance between effectiveness in suppressing myopia progression and tolerability of the spectacle lens is often not reliably achieved. For minus lenses for the correction of myopia, for example, it can be seen that with the same central zone (i.e. the same central main viewing region) of the spectacle lens, the size of the central field of sight increases with higher myopia. This results in temporarily improved tolerability of the spectacle lens, while maintaining the same effectiveness for myopia management, i.e. the tolerability and effectiveness for myopia management are no longer in the desired balance. This can therefore, at least in the medium or long term, lead to a more pronounced progression of myopia compared to a spectacle lens with an optimal balance between tolerability and effectiveness, and thus to a decrease in tolerability or wearing comfort for the spectacle lens. A method according to the invention, particularly in the preferred embodiments described here, can very effectively prevent or at least suppress or delay this.

Preferably, the provided user data also comprises a distance measure that (directly or indirectly) specifies or describes the distance b′ of the spectacle lens to be calculated or optimized from the ocular center of rotation of the at least one eye, wherein preferably the horizontal and/or vertical extension of the central main viewing region is/are ascertained based on (or as a function of) the primary refractive power and the distance measure.

The distance measurement can be provided as an individual or standardized variable. It can either directly indicate an individual or standardized distance of the spectacle lens from the ocular center of rotation, or it can, for example, simply indicate an individual or standardized corneal vertex distance (CVD), which then, together with an individual or standardized eye radius, describes the distance b′ of the spectacle lens from the ocular center of rotation. For example, a standardized value for the eye radius could be provided or used together with an individual value for the CVD to describe an individual distance of the spectacle lens from the ocular center of rotation. This could be particularly advantageous in that individual variations in the CVD may be significantly greater than individual variations in the eye radius due to individual variations in the anatomy of the head and eyes, on the one hand, but also due to the dependence on a selected spectacle frame and wearing habits. On the other hand, an individual CVD for a selected spectacle frame can be determined quite reliably using simple means.

In a particularly preferred embodiment, the horizontal and/or vertical extension of the central main viewing region is ascertained for a negative value of the primary refractive power as a (at least partially) monotonically decreasing function of the distance b′ of the spectacle lens from the ocular center of rotation, and is ascertained for a positive value of the primary refractive power as a (at least partially) monotonically increasing function of the distance b′ of the spectacle lens from the ocular center of rotation. Alternatively or in addition, the horizontal and/or vertical extension of the central main viewing region is preferably ascertained for a negative value of the primary refractive power as a (at least partially) monotonically increasing function of the product of the distance b′ of the spectacle lens from the ocular center of rotation and the primary refractive power, and is ascertained for a positive value of the primary refractive power as a (at least partially) monotonically increasing function of the product of the distance b′ of the spectacle lens from the ocular center of rotation and the primary refractive power.

Particularly preferably, the horizontal extension r′ₕ and/or the vertical extension r′ᵥ of the central main viewing region is/are ascertained
for negative values of the primary refractive power according to

$${{r}_{h} / ( 1 - {s}_{o} b ‘ F ) \leq r ’}_{h} < {r}_{h}$$

or according to

$${{r}_{v} / ( 1 - {s}_{o} b ‘ F ) \leq r ’}_{v} < {r}_{v}$$

and/or
for positive values of the primary refractive power according to

$${{r}_{h} < r ’}_{h} \leq {r}_{h} / ( 1 - {s}_{o} b ‘ F )$$

or according to

$${{r}_{v} < r ’}_{v} \leq {r}_{v} / ( 1 - {s}_{o} b ‘ F )$$

as a function of the primary refractive power F and the distance b′ of the spectacle lens from the ocular center of rotation with a specified reference value rₕ for the horizontal extension or a specified reference value rᵥ for the vertical extension of the central main viewing region and a specified positive upper weighting factor sₒ.

Further preferably, the horizontal extension r′ₕ and/or the vertical extension r′ᵥ of the central main viewing region is/are ascertained
for negative values of the primary refractive power according to

$${{r}_{h} / ( 1 - {s}_{o} b ‘ F ) \leq r ’}_{h} \leq {r}_{h} / ( 1 - {s}_{u} b ‘ F )$$

or according to

$${{r}_{v} / ( 1 - {s}_{o} b ‘ F ) \leq r ’}_{v} \leq {r}_{v} / ( 1 - {s}_{u} b ‘ F )$$

and/or
for positive values of the primary refractive power according to

$${r}_{h} / ( 1 - {s}_{u} b ‘ F ) \leq r ’ h \leq {r}_{h} / ( 1 - {s}_{o} b ‘ F )$$

or according to

$${{r}_{v} / ( 1 - {s}_{u} b ‘ F ) \leq r ’}_{v} \leq {r}_{v} / ( 1 - {s}_{o} b ‘ F )$$

as a function of the primary refractive power F and the distance b′ of the spectacle lens from the ocular center of rotation with a specified reference value rₕ for the horizontal extension or a specified reference value rᵥ for the vertical extension of the central main viewing region, as well as a specified positive upper weighting factor sₒ and a specified positive lower weighting factor sᵤ, which is not greater (but preferably smaller) than the upper weighting factor.

The upper weighting factor is preferably in a range of not greater than about 1.5, preferably not greater than about 1.2, most preferably not greater than about 1.0 and/or in a range of at least about 0.3, preferably at least about 0.5, even more preferably at least about 0.8, most preferably at least about 1.0. Alternatively or in addition, the lower weighting factor is preferably in a range of at least about 0.1, preferably at least about 0.3, more preferably at least about 0.5, most preferably at least about 0.8, and/or in a range of not greater than about 1.0, preferably not greater than about 0.8, more preferably not greater than about 0.5, most preferably not greater than about 0.3.

Further preferably, a difference sₒ−sᵤ between the upper weighting factor sₒ and the lower weighting factor sᵤ is not greater than about 1.0, preferably not greater than about 0.8, more preferably not greater than about 0.5, even more preferably not greater than about 0.3, or even not greater than about 0.2, most preferably not greater than about 0.1.

In a preferred variant, the upper weighting factor sₒ and the lower weighting factor sᵤ correspond to a positive weighting factor s. In other words, the horizontal extension r′ₕ and/or the vertical extension r′ᵥ of the central main viewing region is/are preferably ascertained according to

$${r ’}_{h} = {r}_{h} / ( 1 - sb ‘ F )$$

or according to

$${r ’}_{v} = {r}_{v} / ( 1 - sb ‘ F )$$

as a function of the primary refractive power F and the distance b′ of the spectacle lens from the ocular center of rotation with a specified reference value rₕ for the horizontal extension or a specified reference value rᵥ for the vertical extension of the central main viewing region as well as a specified positive weighting factor s, the value of which is in particular in a range of not more than about 1.0 and/or in a range of at least about 0.3, preferably at least about 0.5.

The method preferably comprises:
specifying a parameterization of a first refractive surface and a second refractive surface for the spectacle lens to be calculated or optimized;
iteratively evaluating a target function and varying the parameterization of at least one of the refractive surfaces for the spectacle lens to be calculated or optimized to minimize the target function, wherein the target function specifies at least one distribution of target specifications for the spherical equivalent across the spectacle lens such that, for viewing points that lie within the main viewing region according to the ascertained horizontal and/or vertical extension of the main viewing region, the target specifications for the spherical equivalent are specified to the primary refractive power; and
outputting the parameterization of the at least one varied refractive surface resulting after minimization of the target function.

For the calculation or optimization of spectacle lenses, particularly as individually calculated or optimized (and then manufactured) spectacle lenses, it is thus desirable to achieve the best possible correction of a refractive error in the eye of the spectacle wearer for various viewing directions. In general, a spectacle lens is considered fully corrective for a given viewing direction if the values for sphere, cylinder, and axis of the wavefront when passing the vertex sphere (or an alternative evaluation surface) match the values for sphere, cylinder, and axis of the prescription for the eye having the vision defect. When determining refraction for an eye of the spectacle wearer, dioptric values (in particular sphere, cylinder, and axial position—i.e. sphero-cylindrical deviations) are determined for a far (usually infinite) distance and, if necessary (for multifocal or progressive lenses) an addition for a near distance (e.g. according to DIN 58208), which values are to serve as the basis for the calculation or optimization (and thus for the production) of the lens.

Complete correction for all viewing directions simultaneously is not normally possible. Therefore, the spectacle lenses are manufactured in such a way that they provide good correction of vision defects of the eye and only minimal aberrations, especially in the main regions of use, particularly in the central viewing regions, while allowing or even deliberately creating larger aberrations in peripheral regions.

In order to be able to manufacture a spectacle lens in this way, the lens surfaces, or at least one of the lens surfaces, are preferably first calculated in such a way as to achieve the desired distribution of the inevitable and/or deliberately placed aberrations. This calculation and optimization is preferably carried out using an iterative variational method by minimizing a target function. In particular, a function Fz with the following functional relationship to the spherical power S, the magnitude of the cylindrical power Z, and the axis of the cylinder a (also referred to as the “SZA” combination) is considered and minimized as the target function:

$${F}_{Z} = {\sum }_{i = 1}^{m} [ {{g}_{i , S Δ} ( {S}_{Δ , i} - {S}_{Δ , i , target} )}^{2} + {{g}_{i , Z Δ} ( {Z}_{Δ , i} - {Z}_{Δ , i , target} )}^{2} + … ]$$

In the target function Fz, at the evaluation points i of the spectacle lens, at least the actual refractive deficits of the spherical power S_{Δ,i} and the cylindrical power Z_{Δ,i} as well as target specifications for the refractive deficits of the spherical power S_{Δ,i,target} and the cylindrical power Z_{Δ,i,target} are taken into consideration. The distribution of the target specifications or target values and the weighting factors gᵢ in the target function is also referred to as the design of the spectacle lens.

The basic procedure for calculating and optimizing spectacle lenses using such a target function is known in principle. Within the scope of the present invention, however, a preferred embodiment proposes that, with regard to the design of the spectacle lens, i.e. the spatial distribution of target specifications, at least the target specifications for the spherical component S of the power be determined across the spectacle lens in such a way that for viewing points i that lie within the main viewing region according to the ascertained horizontal and/or vertical extension of the main viewing range, the target specifications for the spherical equivalent are determined to the primary refractive power F.

Preferably, the target function also sets the distribution of target specifications for the spherical equivalent across the spectacle lens such that, for viewing points that lie within the effect region according to the ascertained horizontal and/or vertical extension of the main viewing region, the target specifications for the spherical equivalent are set to the secondary refractive power, which is higher than the primary refractive power.

Preferably, a spectacle lens is calculated or optimized that further comprises:
a peripheral region outside the effect region with a substantially constant refractive power, which substantially corresponds to the substantially constant refractive power in the central main viewing region,

wherein the method comprises:
ascertaining a maximum horizontal and/or vertical extension of the effect region based on (or as a function of) the primary refractive power (and preferably the distance b′ of the spectacle lens from the ocular center of rotation).

In a further aspect, the invention relates to a method for producing a spectacle lens, comprising:
calculating or optimizing a spectacle lens according to the method for calculating or optimizing a spectacle lens in one of the embodiments described here; and
manufacturing the spectacle lens thus calculated or optimized.

In a further aspect, the invention relates to a series of spectacle lenses comprising a plurality of spectacle lenses, each of which comprises:
a central main viewing region with a substantially constant refractive power, the primary refractive power; and
an effect region adjacent to the central main viewing region, which causes
   at least partially a higher refractive power than the refractive power in the central main viewing region and/or
   at least partially a reduction in contrast (of an image through the spectacle lens), wherein the plurality of spectacle lenses in the series differ in pairs both in the value of the primary refractive power and in a horizontal and/or vertical extension of the central main viewing region such that, between the spectacle lenses in the series, the horizontal and/or vertical extension of the central main viewing region varies as a (at least partially) monotonically increasing function of the primary refractive power of the respective spectacle lens. In other words, in a pairwise comparison of two spectacle lenses in the series with different primary refractive powers, the horizontal and/or vertical extension of the central main viewing region is greater for the lens with the greater (i.e. more positive or less negative) primary refractive power. In a preferred embodiment, the horizontal extension and/or the vertical extension of the central main viewing region within the series of spectacle lenses depends substantially on the primary refractive power in one of the functional ways described in connection with the methods for calculating or optimizing a spectacle lens.

In a further aspect, the invention provides a device for calculating or optimizing a spectacle lens for at least one eye of a spectacle wearer, such that the spectacle lens comprises:
a central main viewing region with a substantially constant refractive power; and
an effect region adjacent to the central main viewing region, which causes
   at least partially a higher refractive power, the secondary refractive power, than the refractive power in the central main viewing region and/or
   at least partially a reduction in contrast (of an image through the spectacle lens), wherein the device comprises:
a data interface for acquiring user data comprising at least a spherical equivalent of a refractive deficit of the at least one eye;
a determination module for determining a primary refractive power as the substantially constant refractive power of the central main viewing region for correcting the spherical equivalent of the refractive deficit of the at least one eye; and
an ascertaining module for ascertaining a horizontal and/or vertical extension of the central main viewing region based on the primary refractive power.

Preferably, the device for calculating or optimizing a spectacle lens is configured to carry out a method for calculating or optimizing a spectacle lens in one of the preferred embodiments described here.

In a further aspect, the invention relates to a computer program product which, when loaded and executed on a computer, is configured to carry out a method for calculating or optimizing a spectacle lens according to one of the embodiments described here.

In a further aspect, the invention relates to a device for producing a spectacle lens, comprising:
calculation or optimization means configured to calculate or optimize the spectacle lens according to a method for calculating or optimizing a spectacle lens according to one of the embodiments described here;
processing means configured to finish the spectacle lens.

Finally, the invention relates to a use of a spectacle lens calculated or optimized according to the method according to one of the embodiments described here and/or a spectacle lens produced according to a production method described here for compensating for a myopic vision defect and/or for reducing the progression of myopia.

### BRIEF DESCRIPTION OF THE DRAWINGS

The invention will be further described below using preferred embodiments with reference to the accompanying drawings, which show:

FIGS. 1 to 3 illustrate schematic plan views of different examples of possible refractive power distributions on spectacle lenses produced according to the invention; and

FIG. 4 illustrates a schematic representation of the beam path for a minus lens to illustrate conceptual explanations of the invention.

### DETAILED DESCRIPTION

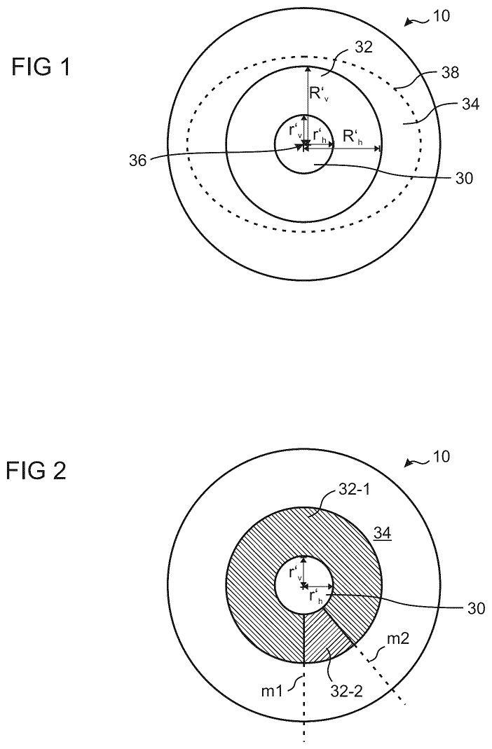

FIG. 1 shows a plan view of an exemplary spectacle lens 10. In this example, the spectacle lens is initially shown as an uncut spectacle lens (before cutting). This uncut spectacle lens can then be fitted into a corresponding frame, for example, along an edge 38 by cutting.

As shown in FIG. 1, the spectacle lens 10 in this example comprises a central main viewing region 30 with a substantially constant refractive power, the primary refractive power F. This central main viewing region 30 is positioned in front of the respective eye of the wearer (user) by appropriately centering the spectacle lens such that the wearer, when looking in a main viewing direction, substantially looks in the region of a center 36 of the central main viewing region 30. The spherical equivalent of the vision defect and preferably all refractive errors of the user's eye to be corrected are corrected as effectively as possible by the central main viewing region 30. This ensures that the wearer has sharp foveal vision in the main viewing direction with this spectacle lens.

The spectacle lens also comprises an effect region 32 adjacent to the central main viewing region 30, which in this case is arranged particularly around the central main viewing region 30. The effect region 32 creates an at least partially higher refractive power (positive dioptric addition power) than the refractive power in the central main viewing region 30 and/or at least partially a reduction in contrast. This can be achieved, for example, at least partially by microstructures, for example in the form of microlenses (lenslets), in the effect region 32.

Particularly in the case of a positive dioptric addition power in the effect region 32, the (middle) peripheral visual field is imaged slightly in front of the corresponding eye of the spectacle wearer in the case of sharp vision in the central region (foveal vision). This suppresses growth of the eyeball's length, which leads to a reduction in the progression of a myopic characteristic of the eye and thus to improved long-term wearing comfort for the lens.

In order to be able to effectively control the desired balance between tolerability and effectiveness of this myopia progression-suppressing effect, a horizontal extension r′ₕ and/or a vertical extension r′ᵥ of the central main viewing region 30 with the substantially constant refractive power F is specified as a function of this refractive power (primary refractive power F), as will be described in more detail later by way of example.

Finally, the spectacle lens 10 in this variant also comprises a peripheral region 34 outside the effect region 32, again with a substantially constant refractive power. Particularly preferably, the substantially constant refractive power in the peripheral region 34 substantially corresponds to the substantially constant refractive power in the central main viewing region 30. Thus—assuming a substantially approximately isotropic eye length—the far peripheral field of vision is again imaged at least approximately sharply on the retina of the corresponding eye. On the one hand, this creates a pleasant visual sensation with a fairly wide field of vision and, on the other hand, increases safety when wearing the spectacle lens, as peripheral movements and thus potential obstacles and hazards can be detected earlier and more reliably by the wearer in this way. Overall, this in turn contributes to better long-term wearing comfort, especially if a horizontal extension R′ₕ and/or a vertical extension R′ᵥ of the effect region 32 is again determined as a function of the primary refractive power F.

In the schematic, exemplary embodiment of FIG. 1, the central main viewing region 30 and the effect region 32 are shown as circular. Thus, in this example, the central main viewing region 30 has the same horizontal r′ₕ and vertical extension r′ᵥ, in particular as the radius of the circular area that forms the central main viewing region 30. Accordingly, in this example, the effect region 32 also has the same horizontal R′_{H} and vertical extension R′ᵥ, particularly as the outer boundary radius of the circular ring that forms the effect region 32. However, this is not necessarily the case. These regions can also have other shapes (e.g. oval). These regions do not necessarily have to be concentric with each other, although this may be particularly advantageous for some universal applications.

In a preferred embodiment illustrated in FIG. 2, the effect region 32 includes a near-vision portion 32-2 located within a segment of the spectacle lens and encompassing a segment of the effect region 32 that is bounded temporally by a vertical meridian line m1 downward from the center of the central main viewing region 30, and nasally, in this case, by a meridian line m2, rotated nasally by approximately 30° to the vertical, downward from the center of the central main viewing region. The optical properties of the segment of the effect region encompassed by the near-vision portion 32-2 differ at least partially from the optical properties of the remaining effect region 32-1, particularly with regard to their positive dioptric addition power and/or their reduction in contrast.

While the embodiment of FIG. 1 could be implemented in particular as a single-vision lens, the embodiment of FIG. 2 is suitable, for example, as a progressive lens. With regard to the balance between tolerability and effectiveness of the myopia management effect, both fields of application can benefit analogously from the inventive determination of the (maximum) extension of the central main viewing region 30 as a function of the primary refractive power F.

Yet another example of a possible arrangement of an effect region is schematically shown in FIG. 3. Here, a channel region 12 extends continuously from an upper edge 14 of the spectacle lens 10 to a lower edge 16 of the spectacle lens 10. This channel region 12 serves as the clear vision region or prescription region of the spectacle lens 10 when the correct prescription is applied for the corresponding eye, allowing the wearer to see clearly through this region, as this region largely compensates for any vision defect of the eye.

The channel region 12 comprises, in particular, the central main viewing region 30, which can be used, in particular, for the user to look straight ahead (or to look into the distance toward the horizon) and has a substantially constant primary refractive power F. Adjacent to both sides (horizontally) of the channel region 12 and thus also to the central main viewing region 30 is the effect region, which in this example is divided into a nasal effect portion 32n and a temporal effect portion 32t, which are directly adjacent to the channel region 12, in particular along a respective nasal channel boundary line 26n and temporal channel boundary line 26t, and thus also delimit the central main viewing region 30 at least in the horizontal extension rₕ. The two effect portions 32n, 32t together form the effect region, in which the spectacle lens 10 substantially has a higher refractive power and/or reduction in contrast compared to the prescription data implemented in the channel region. This variant of the arrangement of the central main viewing region 30 and the effect region 32 also benefits from the inventive definition of the (maximum) extension of the central main viewing region 30, at least in the horizontal direction, as a function of the primary refractive power F, in terms of the balance between tolerability and effectiveness of the myopia management effect.

As already explained, a special idea lies in reliably achieving the optimal balance between tolerability of the spectacle lenses and their effectiveness in reducing the progression of management for all corrective powers. To this end, it is proposed to create a basic design of a spectacle lens for myopia management with a central main viewing region for good vision in this region and a peripheral effect region that serves to control myopia progression. This basic design is configured to ensure an optimal distribution of tolerability on the one hand and the preventive power on the other for a specific corrective power as a basic design reference (e.g. for F=0 dpt).

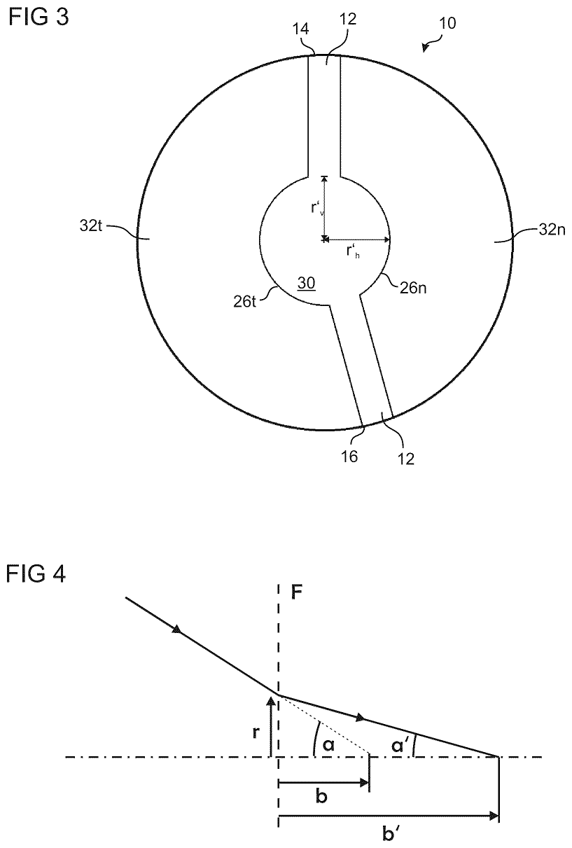

As schematically shown in FIG. 4, the size a of the field of sight of the central main viewing region, which proves to be crucial for the tolerability of the spectacles, can be determined by the radius of the central main viewing region r and the distance b′ of the spectacle lens from the ocular center of rotation (significantly influenced by the CVD) (neglecting the lens's intrinsic magnification). Substantially, the following applies:

$$- α b = r = - α ‘ b ‘$$

The size of the field of sight α, α′ of the central main viewing region varies for a constant physical size r on the spectacle lens due to the dynamic distortion caused by the corrective effect according to

$$α ‘ = ( 1 - b ’ F ) α ,$$

where F is the corrective power (spherical equivalent of the refractive power). For minus lenses (F<0) used to correct myopia, this means that for the same (horizontal and/or vertical) extension of the central main viewing region of the spectacle lens, the size of the central field of sight increases with higher myopia. While this temporarily improves tolerability of the spectacle lens, its tolerability and effectiveness for myopia management are no longer in optimal balance.

To ensure this optimal balance between tolerability and effectiveness for spectacle lenses with a wide range of prescriptions, the size (i.e., the horizontal and/or vertical extension) of the central main viewing region is adjusted based on the dynamic distortion (i.e. in particular based on the primary refractive power F of the spectacle lens), e.g. preferably according to

$$r ‘ = 1 / ( 1 - sb ‘ F ) r ,$$

where r′ is the radius (in particular as a measure of horizontal and/or vertical extension) of the adjusted central main viewing region, and s is a positive weighting factor, which is particularly preferably selected within a value range of up to about 1. The value r is, in particular, a predetermined reference value for the (horizontal and/or vertical) extension of the central main viewing region, which, particularly for F=0, achieves the desired or predetermined balance according to the basic design.

As a result, the boundary between the central main viewing region and the effect region shifts depending on the refractive power, so that in a particularly reliable balance with greater myopia (and thus more negative primary refractive power, and thus greater distortion of the spectacle lens), more surface area (or a surface area extending closer to the center) is achieved for the positive addition power or reduction in contrast by the effect region.

This means that a single basic lens design can achieve a very wide range of different primary refractive power values (i.e. different visual impairments) with at least an approximately consistently reliable balance between tolerability and myopia-stopping effect. This was not guaranteed in an equally efficient and reliable manner with conventional lenses and their calculation, optimization, and production methods.

1-18. (canceled)

19. A method for calculating or optimizing a spectacle lens for at least one eye of a spectacle wearer such that the spectacle lens comprises a central main viewing region with a substantially constant refractive power, and an effect region adjacent to the central main viewing region, which causes at least partially a higher refractive power, which is a secondary refractive power, than a refractive power in the central main viewing region and/or at least partially a reduction in contrast, wherein the method comprises:
providing user data including at least a spherical equivalent of a refractive deficit of the at least one eye;
determining a primary refractive power as the substantially constant refractive power of the central main viewing region for correcting the spherical equivalent of the refractive deficit of the at least one eye; and
ascertaining a horizontal and/or vertical extension of the central main viewing region based on the primary refractive power,
wherein the provided user data also includes a distance measure that specifies a distance of the spectacle lens to be calculated or optimized from an ocular center of rotation of the at least one eye, and
wherein the horizontal and/or vertical extension of the central main viewing region; is/are:
ascertained based on the primary power and the distance measure,
ascertained for a negative value of the primary refractive power as a monotonically decreasing function of the distance of the spectacle lens from the ocular center of rotation, and
ascertained for a positive value of the primary refractive power as a monotonically increasing function of the distance of the spectacle lens from the ocular center of rotation.

20. The method according to claim 19, wherein the horizontal and/or vertical extension of the central main viewing region is ascertained as a monotonically increasing function of the primary refractive power of the spectacle lens.

21. (canceled)

22. (canceled)

23. The method according to claim 19, wherein the horizontal extension r′ₕ and/or the vertical extension r′ᵥ of the central main viewing region is/are respectively ascertained:
for negative values of the primary refractive power according to
$${{r}_{h} / ( 1 - {s}_{o} b ‘ F ) \leq r ’}_{h} < {r}_{h}$$
or according to
$${r}_{v} / ( 1 - {s}_{o} b ‘ F ) \leq r {‘}_{v} < {r}_{v} ,$$
and/or
for positive values of the primary refractive power according to
$${{r}_{h} < r ’}_{h} \leq {r}_{h} / ( 1 - {s}_{o} b ‘ F )$$
or according to
$${r}_{v} < {r}_{v} \leq {r}_{v} / ( 1 - {s}_{o} b ‘ F )$$
as a function of the primary refractive power F and the distance b′ of the spectacle lens from the ocular center of rotation with a specified reference value rₕ for the horizontal extension or a specified reference value rᵥ for the vertical extension of the central main viewing region and a specified positive upper weighting factor sₒ.

24. The method according to claim 19, wherein the horizontal extension r′ₕ and/or the vertical extension r′ᵥ of the central main viewing region is/are respectively ascertained:
for negative values of the primary refractive power according to
$${{r}_{h} / ( 1 - {s}_{o} b ‘ F ) \leq r ’}_{h} \leq {r}_{h} / ( 1 - {s}_{u} b ‘ F )$$
or according to
$${{r}_{v} / ( 1 - {s}_{o} b ‘ F ) \leq r ’}_{v} \leq {r}_{v} / ( 1 - {s}_{u} b ‘ F ) ,$$
and/or
for positive values of the primary refractive power according to
$${{r}_{h} / ( 1 - {s}_{u} b ‘ F ) \leq r ’}_{h} \leq {r}_{h} / ( 1 - {s}_{o} b ‘ F )$$
or according to
$${{r}_{v} / ( 1 - {s}_{u} b ‘ F ) \leq r ’}_{v} \leq {r}_{v} / ( 1 - {s}_{o} b ‘ F )$$
as a function of the primary refractive power F and the distance b′ of the spectacle lens from the ocular center of rotation with a specified reference value rₕ for the horizontal extension or a specified reference value rᵥ for the vertical extension of the central main viewing region, as well as a specified positive upper weighting factor sₒ and a specified positive lower weighting factor sᵤ, which is not greater than the upper weighting factor.

25. The method according to claim 23,
wherein the upper weighting factor is in a range of not greater than about 1.5 and/or in a range of at least about 0.3, and/or
wherein the lower weighting factor is in a range of not greater than about 1.0.

26. The method according to claim 24,
wherein a difference sₒ−sᵤ between the upper weighting factor sₒ and the lower weighting factor sᵤ is not greater than about 1.0.

27. The method according to claim 24,
wherein the upper weighting factor sₒ and the lower weighting factor sᵤ correspond to a positive weighting factor s, the value of which is in a range of not more than about 1.0 and/or in a range of at least about 0.3, preferably at least about 0.5.

28. The method according to claim 19, further comprising:
specifying a parameterization of a first refractive surface and a second refractive surface for the spectacle lens to be calculated or optimized;
iteratively evaluating a target function and varying the parameterization of at least one of the refractive surfaces for the spectacle lens to be calculated or optimized to minimize the target function, wherein the target function sets at least one distribution of target specifications for the spherical equivalent across the spectacle lens such that, for viewing points that lie within the main viewing region according to the ascertained horizontal and/or vertical extension of the main viewing region, the target specifications for the spherical equivalent are set to the primary refractive power; and
outputting the parameterization of the at least one varied refractive surface resulting after minimization of the target function.

29. The method according to claim 28, wherein the target function sets the distribution of target specifications for the spherical equivalent across the spectacle lens such that, for viewing points that lie within the effect region according to the ascertained horizontal and/or vertical extension of the main viewing region, the target specifications for the spherical equivalent are set to the secondary refractive power.

30. The method according to claim 19 for calculating or optimizing a spectacle lens that further includes a peripheral region outside the effect region with a substantially constant refractive power, which substantially corresponds to the substantially constant refractive power in the central main viewing region, wherein the method further comprises:
ascertaining a maximum horizontal and/or vertical extension of the effect region based on the primary refractive power.

31. A method for producing a spectacle lens, comprising:
calculating or optimizing a spectacle lens according to the method for calculating or optimizing a spectacle lens according to claim 19; and
manufacturing the spectacle lens thus calculated or optimized.

32. A series of spectacle lenses comprising a plurality of spectacle lenses, each of which comprises:
a central main viewing region with a substantially constant refractive power, the primary refractive power; and
an effect region adjacent to the central main viewing region, which causes:
at least partially a higher refractive power than the refractive power in the central main viewing region, and/or
at least partially a reduction in contrast,
wherein each spectacle lens in the series is configured for a distance of the spectacle lens from an ocular center of rotation of an eye, and
wherein the plurality of spectacle lenses in the series differ in pairs both in a value of the primary refractive power and in a horizontal and/or vertical extension of the central main viewing region such that, between the spectacle lenses in the series, the horizontal and/or vertical extension of the central main viewing region:
varies as a monotonically increasing function of the primary refractive power of the respective spectacle lens,
varies for a negative value of the primary refractive power as a monotonically decreasing function of the distance of the spectacle lens from the ocular center of rotation, and
varies for a positive value of the primary refractive power as a monotonically increasing function of the distance of the spectacle lens from the ocular center of rotation.

33. A device for calculating or optimizing a spectacle lens for at least one eye of a spectacle wearer, such that the spectacle lens includes a central main viewing region with a substantially constant refractive power, and an effect region adjacent to the central main viewing region, which causes at least partially a higher refractive power, which is a secondary refractive power, than the refractive power in the central main viewing region, and/or at least partially a reduction in contrast, wherein the device comprises:
a data interface configured to acquire user data comprising at least a spherical equivalent of a refractive deficit of the at least one eye;
a determination module configured to determine a primary refractive power as the substantially constant refractive power of the central main viewing region for correcting the spherical equivalent of the refractive deficit of the at least one eye; and
an ascertaining module configured to ascertain a horizontal and/or vertical extension of the central main viewing region based on the primary refractive power,
wherein the acquired user data also includes a distance measure that specifies a distance of the spectacle lens to be calculated or optimized from an ocular center of rotation of the at least one eye, and
wherein the horizontal and/or vertical extension of the central main viewing region: is/are;
ascertained based on the primary refractive power and the distance measure,
ascertained for a negative value of the primary refractive power as a monotonically decreasing function of the distance of the spectacle lens from the ocular center of rotation, and
ascertained for a positive value of the primary refractive power as a monotonically increasing function of the distance of the spectacle lens from the ocular center of rotation.

34. A non-transitory computer program product which, when loaded and executed on a computer, is configured to carry out a method for calculating or optimizing a spectacle lens according to claim 19.

35. A device for producing a spectacle lens, comprising:
a calculator or optimized configured to calculate or optimize the spectacle lens according to a method for calculating or optimizing a spectacle lens according to claim 19; and
a processor configured to finish the spectacle lens.
